(19) United States
(12) Patent Application Publication
(10) Pub. No.: US 2025/0366634 A1
(43) Pub. Date: Dec. 4, 2025

(54) MODULAR ACCESSORY WALL PANELS

(71) Applicant: Ford Global Technologies, LLC, Dearborn, MI (US)

(72) Inventors: Matthew B. Rutman, Westland, MI (US); Eric Scott Levine, Novi, MI (US); Blaise Nugent, Brighton, MI (US); Todd Rakus, Windsor (CA)

(21) Appl. No.: 18/676,737

(22) Filed: May 29, 2024

(51) Int. Cl. A47F 5/08; B60R 9/06

(52) U.S. Cl. CPC A47F 5/083; B60R 9/06

(57) ABSTRACT

An attachment structure comprises a base support comprising at least a first base support application and a second base support application that is different than the first base support application. At least one base plate is mountable to the base support, wherein the at least one base plate includes a plurality of apertures configurable to receive mounting feet from one or more accessories. The plurality of apertures comprise a plurality of sub-groups that each comprise a predetermined pattern that includes at least one mounting aperture, at least one locking aperture, and at least one power interface aperture. The predetermined pattern is the same for the first base support application and the second base support application.

### TECHNICAL FIELD

This disclosure relates generally to a modular base plate configuration that is compatible with base plates as used in a cargo area of a vehicle, and more particularly, to a modular base plate configuration that can be attached to a supporting structure in a non-vehicle application such that accessories can be easily and quickly interchanged between being mounted to a base plate in a vehicle application and being mounted to a base plate in a non-vehicle application.

### BACKGROUND

Vehicles transport various types of cargo including accessories, such as bins, containers, and tools, for example. The accessories can vary in size and shape. Support surfaces in a vehicle cargo area or other type of work area may be configured to securely support the accessories.

In some aspects, the techniques described herein relate to an attachment structure, including: a base support comprising at least a first base support application and a second base support application that is different than the first base support application; at least one base plate mountable to the base support, wherein the at least one base plate includes a plurality of apertures configurable to receive mounting feet from one or more accessories, wherein the plurality of apertures comprise a plurality of sub-groups that each comprise a predetermined pattern that includes at least one mounting aperture, at least one locking aperture, and at least one power interface aperture; and wherein the predetermined pattern is the same for the first base support application and the second base support application.

In some aspects, the techniques described herein relate to any of the described attachment structures, and further including wherein the first base support application comprises a vehicle cargo area.

In some aspects, the techniques described herein relate to any of the described attachment structures, and further including wherein the second base support application comprises a supporting structure that is separate from the vehicle cargo area.

In some aspects, the techniques described herein relate to any of the described attachment structures, and further including wherein the at least one base plate comprises at least one first base plate mounted in the vehicle cargo area and at least one second base plate mounted to the supporting structure, wherein the first base plate includes at least one sub-group of the plurality of sub-groups and the second base plate includes at least one sub-group of the plurality of sub-groups, such that the one or more accessories can be selectively detached from one of the at least one first base plate and the at least one second base plate and selectively attached to the other of the at least one first base plate and the at least one second base plate.

In some aspects, the techniques described herein relate to any of the described attachment structures, and further including wherein the at least one base plate comprises a plurality of base plates, and wherein each base plate comprises an outer peripheral edge that includes a plurality of mount features, wherein a first mount feature from the plurality of mount features on a first base plate of the plurality of base plates overlaps a second mount feature from a second base plate of the plurality of base plates to secure the first base plate and the second base plate together.

In some aspects, the techniques described herein relate to any of the described attachment structures, and further including a plurality of fasteners that are used to secure overlapping first and second mount features from the plurality of mount features together.

In some aspects, the techniques described herein relate to any of the described attachment structures, and further including wherein the first mount feature and the second mount feature are offset from each other in a direction along an insertion axis for an associated fastener from the plurality of fasteners.

In some aspects, the techniques described herein relate to any of the described attachment structures, and further including wherein each base plate includes an outer accessory support surface and an inner surface that faces the base support, and wherein the plurality of mount features comprise bosses that extend outwardly of the outer peripheral edge and which are spaced apart from the outer accessory support surface in a direction toward the inner surface.

In some aspects, the techniques described herein relate to any of the described attachment structures, and further including a plurality of alignment features, wherein alignment features for one of the first base plate and the second base plate comprise female structures and alignment features for the other of the first base plate and the second base plate comprise male structures that fit into corresponding female structures.

In some aspects, the techniques described herein relate to any of the described attachment structures, and further including wherein each base plate includes at least two alignment features associated with each mount feature, and wherein one of the at least two alignment features is on one side of each mount feature and the other of the at least two alignment features is on an opposite side of each mount feature.

In some aspects, the techniques described herein relate to any of the described attachment structures, and further including wherein the at least one base plate comprises at least one first base plate associated with the first base support application and at least one second base plate associated with the second base support application, and wherein, for each sub-group, the at least one mounting aperture comprises a plurality of mounting apertures, the at least one locking aperture comprises a plurality of locking apertures, and the at least one power interface aperture comprises a single power interface aperture.

In some aspects, the techniques described herein relate to method including: providing at least a first base support application and a second base support application that is different than the first base support application, wherein one or more accessories is selectively supportable on both the first base support application and the second base support application; configuring at least one base plate to include a plurality of apertures that receive mounting feet from the one or more accessories, wherein the plurality of apertures are comprised of a plurality of sub-groups that each comprise a predetermined pattern that includes at least one mounting aperture, at least one locking aperture, and at least one power interface aperture; and forming the predetermined pattern to be the same for the first base support application and the second base support application.

In some aspects, the techniques described herein relate to any of the described methods, the method further including wherein the first base support application comprises a vehicle cargo area and the second base support application comprises a fixed support structure that is separate from the vehicle cargo area.

In some aspects, the techniques described herein relate to any of the described methods, the method further including wherein the at least one base plate comprises at least one first base plate mounted in the vehicle cargo area and at least one second base plate mounted to the fixed support structure, and including providing the plurality of sub-groups with the predetermined pattern on both the at least one first base plate and the at least one second base plate.

In some aspects, the techniques described herein relate to any of the described methods, the method further including wherein the at least one second base plate comprises a plurality of modular wall plates with mounting bosses formed about a peripheral outer edge of each modular wall plate, and including mounting the plurality of modular wall plates to one or more wall studs by aligning mounting bosses from one modular wall plate to overlap with mounting bosses from an adjacent modular wall plate and inserting at least one fastener through each aligned set of mounting bosses.

In some aspects, the techniques described herein relate to any of the described methods, the method further including wherein the plurality of modular wall plates comprise at least a first modular wall plate and a second modular wall plate, and wherein the mounting bosses include at least a first mounting boss associated with the first modular wall plate and a second mounting boss associated with the second modular wall plate, and including offsetting the first mounting boss from the second mounting boss in a direction along an insertion axis for the at least one fastener.

In some aspects, the techniques described herein relate to any of the described methods, the method further including providing a plurality of alignment features, wherein alignment features for one of the first modular wall plate and the second modular wall plate comprise recesses and alignment features for the other of the first modular wall plate and the second modular wall plate comprise protrusions that fit into corresponding recesses, and including spacing the plurality of alignment features apart from the mounting bosses.

In some aspects, the techniques described herein relate to method, including mounting at least one first base plate in a vehicle cargo area; mounting at least one second base plate to a base structure that is separate from the vehicle cargo area; forming a predetermined pattern of apertures in the at least one first base plate and the at least one second base plate to receive at least one accessory; selectively detaching the at least one accessory from one of the at least one first base plate and the at least one second base plate; and selectively attaching the same at least one accessory to the other of the at least one first base plate and the at least one second base plate.

In some aspects, the techniques described herein relate to any of the described methods, the method further including forming the predetermined pattern of apertures to include at least one mounting aperture for the at least one accessory, at least one locking aperture for the at least one accessory, and at least one power interface aperture for the at least one accessory.

In some aspects, the techniques described herein relate to any of the described methods, the method further including wherein the at least one second base plate comprises a plurality of wall plates with mounting bosses formed about a peripheral outer edge of each wall plate, and including mounting the plurality of wall plates to one or more wall studs by aligning mounting bosses from one wall plate to overlap with mounting bosses from an adjacent wall plate and inserting at least one fastener through each aligned set of mounting bosses.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1A illustrates a perspective view of a vehicle having a cargo area equipped with base plates that can be used to secure an accessory according to an exemplary aspect of the present disclosure.

FIG. 1B is similar to FIG. 1A but shows a different type of vehicle.

FIG. 2 is a schematic illustration of an accessory that is mountable to a base plate.

FIG. 3 is a perspective view of a modular base plate as mounted to wall studs.

FIG. 4 a front view of the modular base plate of FIG. 3.

FIG. 5A is a side view of mount features on peripheral edges of adjacent modular base plates.

FIG. 5B is a top view of the modular base plates of FIG. 5A as attached to each other.

FIG. 6A is a top perspective view of alignment features on a peripheral edge of one type of modular base plate.

FIG. 6B is a bottom perspective view of alignment features on a peripheral edge of another type of modular base plate that attaches to the modular base plate of FIG. 6A.

FIG. 7 is a top view of four modular base plates being attached to each other.

FIG. 8 is a perspective view of the base plates of FIG. 7 as mounted to wall studs.

FIG. 9 shows an alternate arrangement of modular base plates.

### DETAILED DESCRIPTION

The subject disclosure provides a modular base plate mounting structure having a plurality of mounting apertures to which various types of accessory structures can be selectively secured via an attachment interface. The attachment interface includes mounting feet or cleats that are inserted into the mounting apertures. The base plates can be mounted outside of a vehicle to a floor structure or a wall structure in various configurations. The modular base plate mounting structure provides a mounting interface that is interchangeable between a vehicle and a non-vehicle work place.

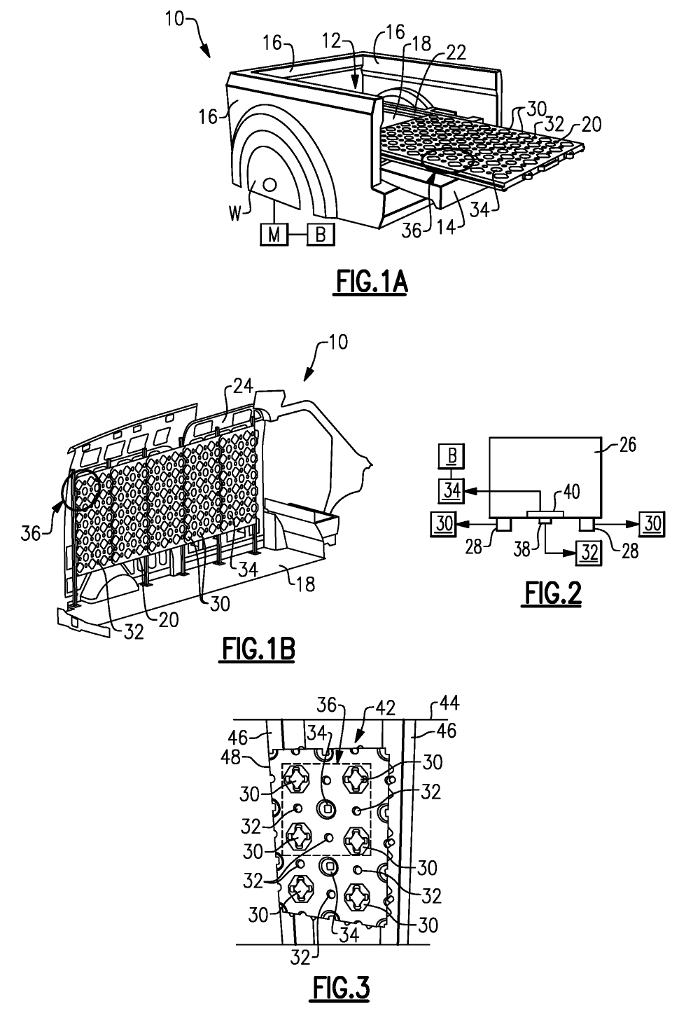

FIGS. 1A and 1B show a vehicle 10 that includes a cargo area 12 that is aft of a passenger compartment (not shown). A tailgate 14 is moveable between open and closed positions to enclose one end of the cargo area 12. The cargo area 12 is further defined by side walls 16 and a floor 18 that supports one or more base plates 20. In this example, the base plates 20 are slidable out of the cargo area 12 on a rail or track system 22 such that the base plates 20 can be removed from the cargo area 12 when the tailgate 14 is in the open position.

In this example, the vehicle 10 is a pickup truck. However, the vehicle 10 could be another type of vehicle in another example, such as a car, van, sport utility vehicle, etc. FIG. 1B shows an example of a vehicle 10 that comprises a van that incorporates one or more base plates 20 onto an upright wall 24.

In one example, the vehicle 10 includes an electrified powertrain capable of applying a torque from an electric machine M (e.g., an electric motor) to drive a least one set of wheels W. The vehicle 10 can include a traction battery pack B, which powers the electric machine M and, potentially, other electrical loads of the vehicle 10. The example vehicle 10 may be an electrified vehicle and, in particular, a battery electric vehicle (BEV). In another example, the vehicle 10 could be another type of electrified vehicle, such as a plug-in hybrid electric vehicle (PHEV), or a conventional vehicle.

The base plates 20 are configured to provide an accessory attachment system where various different types of accessories 26 with mounting feet/cleats 28 that can be selectively attached and detached from the base plates 20. For example, as shown in FIGS. 1A and 1B, the base plates 20 are formed with a plurality of mounting apertures 30 that are configured to receive the mounting feet/cleats 28 of attachment accessories 26. In one example, the base plates 20 also include locking apertures 32 to lock the accessory 26 to the base plate 20 as needed, and power interface apertures 34 to provide power to the accessories 26 as needed.

As shown in FIG. 2, an example accessory 26 includes one or more mounting feet or cleats 28. The accessory 26 can engage the base plate 20 by inserting each mounting cleat 28 into a single mounting aperture 30 to provide a mechanical connection interface. The mounting apertures 30 are spaced upwardly from the floor 18 or side walls 16, 24 by an open gap such that the mounting cleats 28 can be easily inserted into the base plate 20.

As discussed above, the base plate 20 includes a plurality of apertures. In one example, the plurality of apertures are divided into sub-groups 36 of apertures that include at least one type of each different aperture 30, 32, 34. In one example, the power interface apertures 34 and locking apertures 32 of the base plate 20 are spaced apart and separate from each other and from the mounting apertures 30. In one example, the apertures 30, 32, 34 can have shapes and/or sizes that are different from each other. The sub-groups 36 of apertures 30, 32, 34 are provided at multiple locations on the base plate 20, and are formed in a desired pattern on the base plate 20 to allow for the accessories 26 to be mounted in various different locations as needed. In one example, the mounting apertures 30 are formed to have a diamond shape and are larger in size than the power apertures 34 and locking apertures 32.

In one example, the sub-group 76 comprises mounting apertures 30 that are formed in a four corner pattern with a center power aperture 34 between the four corners, and with locking apertures 32 between adjacent mounting apertures 30. This pattern provides for easy and quick connect/disconnect.

In one example, the accessory 26 includes at least one lock 38 that is separate from the mounting feet/cleats 28. Thus, the various accessories 26 can be secured to the vehicle 10 by engaging one or more of the mounting apertures 30 in the base plates 20 via the mounting cleats 28 and then actuating the lock 38 into one of the locking apertures 32. The accessories 26 can comprise, for example, a lockable storage box that holds clothing, tools, a refrigerator, etc. The accessory 26 could also be a lidded lockable container that includes a compartment for storing power tools or other items that require data connection or power connection via the power interface apertures 34. In this configuration, the accessory 26 includes a power interface 40, as schematically shown in FIG. 2 that interacts with the power interface apertures 34. This would allow devices within the accessory 26 to be powered from a vehicle power supply such as the battery pack B, 12V vehicle power, or other power sources via a variety of connections/outlets, for example. Examples of such a power interface connection between an accessory and a base plate can be found in application number 17/716053 and application number 17/716048, which were both filed on April 8, 2022, and which are assigned to the assignee of the subject application, and which are herein incorporated by reference in their entirety.

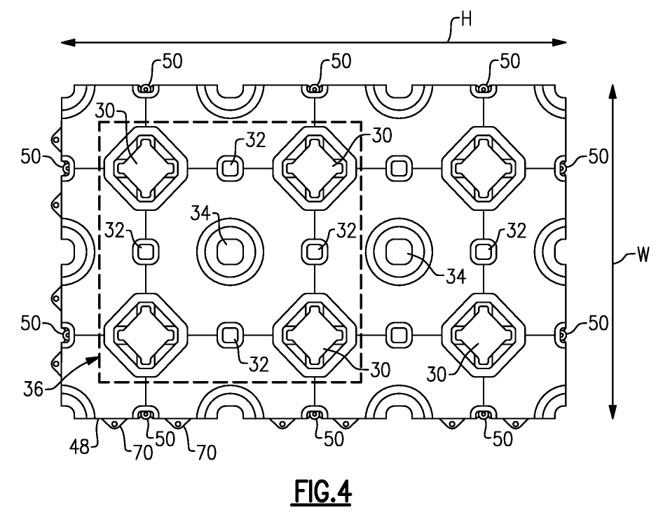

As discussed above, the base plates 20 with the apertures 30, 32, 34 can be mounted to the walls 16, 24 or the floor 18 in the cargo area 12 in a first base support application. The subject disclosure provides for this type of base plate mounting configuration, i.e., a second base support application, that can be used on walls 44 (FIG. 3) in a stationary, non-vehicle application, e.g., a utility trailer, a garage or a shop, to allow accessories to be moved back and forth between the vehicle 10 and a permanent work area.

In one example shown in FIGS. 3-4, a modular base plate 42 is shown that can be mounted directly to wall studs 46, for example. In one example, each modular base plate 42 is sized as a sixteen inch width W by twenty-four inch height H (16”x24”) plate, which is able to be mounted on sixteen inch (16”) and twenty-four inch (24”) stud spacing as typically used in construction. In this example, each modular base plate 42 includes mounting apertures 30 with a diamond shape, locking apertures 32, and power interface apertures 34 on 8” spacing; however, other spacing configurations could also be used. The plurality of apertures are comprised of the sub-groups 36 that each comprise a predetermined pattern that includes at least one mounting aperture 30, at least one locking aperture 32, and at least one power interface aperture 34, and wherein the predetermined pattern is the same for the first base support application and the second base support application. This allows accessories 26 to be selectively detached from one type of base plate 20 or 42 and then selectively attached to the other of the type of base plate 20 or 42.

In one example, for each sub-group 36, the at least one mounting aperture 30 comprises a plurality of mounting apertures 30, the at least one locking aperture 32 comprises a plurality of locking apertures 32, and the at least one power interface aperture 34 comprises a single power interface aperture 34. This type of configuration allows for accessories 26 to be easily installed on the plates in multiple different orientations and rotational positions. In one example, each sub-group 36 includes four mounting apertures 30, four locking apertures 32, and a single power interface aperture 34.

In one example, the base plates 42 have tiling capability (FIGS. 8-9) for proper spacing and the base plates 42 overlap such that fasteners are fastened through aligned bosses on overlapping peripheral edges of adjacent plates such that the base plates 42 are attached directly to the studs 46. This will be discussed in greater detail below.

FIG. 4 shows one example where each modular base plate 42 has an outer peripheral edge 48 that includes a plurality of mount features 50, wherein a first mount feature 50 on a modular base plate 42 overlaps a second mount feature 50 from an adjacent modular base plate 42 to secure two modular base plates 42 together as shown in FIGS. 5A-5B. In one example, a plurality of fasteners 52 are used to secure overlapping first and second mount features 50 together such that adjacent modular base plates 42 are attached directly to the wall studs 46.

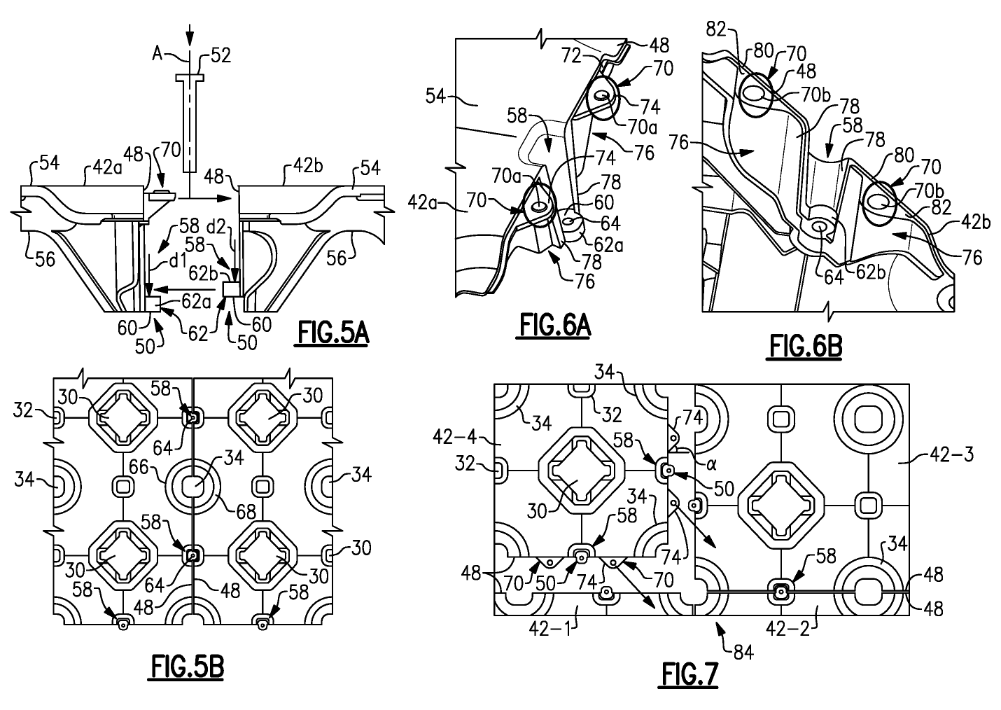

As shown in FIGS. 5A-5B, each modular base plate 42 has an outward surface 54, e.g., an accessory support surface, and an inward surface 56 facing opposite the outward surface 54. In one example, the mount features 50 are formed in recessed pocket areas 58 (see FIG. 6A) that are open to the outward surface 54 and have a distal end 60 located adjacent the inward surface 56. Thus, each pocket area 58 has a depth or length that extends in a direction from the outward surface 54 toward the inward surface 56.

In one example, the plurality of mount features 50 comprise bosses 62 that extend outwardly of the outer peripheral edge 48 in a direction toward an adjacent plate, and which are spaced apart from the outward accessory support surface 54 in a direction toward the inward surface 56. In this example, there are two types of modular base plates 42. A first type of modular base plate 42a has a first boss 62a located at first depth d1 in the pocket area 58 and a second type of modular base plate 42b has a second boss 62b located at second depth d2 in the pocket area 58 that is different than the first depth d1. This offset between the bosses 62a, 62b allows the bosses to overlap each other as shown in FIG. 5B such that the fasteners 52 can be inserted along an insertion axis A through aligned openings 64 formed in the bosses 62a, 62b.

As such, in this example, one mount feature 50 from the first type of modular base plate 42a and another mount feature 50 from the second type of modular base plate 42b are offset from each other in a direction along the insertion axis A of the fastener 52. This fastening arrangement also provides for alignment of the modular base plates 42a, 42b relative to each other. For example, the modular base plates 42, along the peripheral edge 48, may have a portion of one aperture that would need to be aligned with a remaining portion of a corresponding aperture on an adjacent plate. FIG. 5B shows an example where the peripheral edge 48 of the first modular base plate 42a includes one portion 66 of a power interface aperture 34 and the peripheral edge 48 of the second modular base plate 42b includes a remaining portion 68 of the power interface aperture 34. When the fastener 52 is inserted through the aligned openings 64 in the bosses 62a, 62b, the portions 66, 68 are aligned with each other to form a complete power interface aperture 34.

In one example, only partial power interface apertures 34 are located along the peripheral edges 48 of the modular base plates 42, and the mounting apertures 30 and locking apertures 32 are always spaced inward of the peripheral edge 48.

In one example shown in FIGS. 6A-6B, the modular base plates 42 may also include a plurality of alignment features 70, wherein alignment features 70 for one of the first modular base plate 42a and the second modular base plate 42 comprise female structures and alignment features 70 for the other of the first modular base plate 42a and the second modular base plate 42b comprise male structures that fit into corresponding female structures.

In one example, each modular base plate 42 includes at least two alignment features 70 associated with each mount feature 50. In one example, one alignment feature 70 is on one side of each mount feature 50 and another alignment feature 70 is on an opposite side of each mount feature 50.

As discussed above, the bosses 62a, 62b are formed in recessed pocket areas 58 that are open to the outward surface 54. In one example, the first type of modular base plate 42a with the first boss 62a has male alignment features 70a and the second type of modular base plate 42b with second boss 62b has female alignment features 70b. In one example, the male alignment features 70a are provided on a recessed lip area 72 along the peripheral edge 48 of the first type of modular base plate 42a. In one example, one protruding portion 74 extends outward of the recessed lip area 72 on each side of the pocket area 58 in a direction toward an adjacent base plate. In one example, the male alignment features 70a comprise protrusions, tabs, or buttons that extend upward from a surface of the respective protruding portion 74 in a direction toward the outward surface 54 of the first type of modular base plate 42a.

In one example, the peripheral edge 48 of the second type of modular base plate 42b includes recessed pocket areas 76 that are on each side of the pocket area 58. Walls 78 separate the recessed pocket areas 76 from the pocket area 58. In one example, a flange portion 80 extends outward of the peripheral edge 48 of the second type of modular base plate 42b in a direction toward the first type of modular base plate 42a. This flange portion 80 covers an upward end of the recessed pocket areas 76. In one example, the female alignment features 70b are formed as recesses in an inward facing surface 82 of the flange portion 80. When the bosses 62a, 62b are aligned with each other, the flange portions 80 on either side of the pocket area 58 overlap the recessed lip area 72 on each side of the pocket area 58 such that the female alignment features 70b fit into the male alignment features 70a.

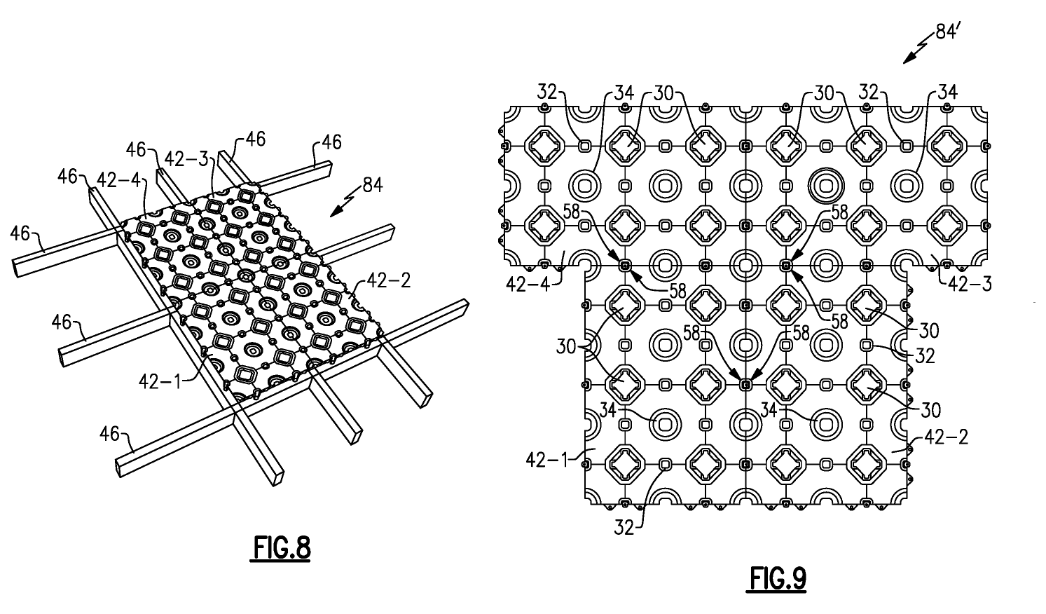

FIG. 7 shows an example where four modular base plates 42-1, 42-2, 42-3, and 42-4 are fit together to form a modular wall structure 84. In the example shown, the modular base plates 42-1, 42-2, 42-3 have already been fit together and only the last corner plate 42-4 needs to be installed. In one example, the edges of the protruding portions 74 of the first type of modular base plate 42a, e.g., corner plate 42-4, extend at a predetermined angle α such that this corner plate 42-4 can be easily installed after the other plates 42-1, 42-2, 42-3 are already fixed in place. In one example, the predetermined angle α comprises a forty-five degree angle extending in a direction normal to the peripheral edge 48; however, other configurations could also be used.

FIG. 8 shows a final installation position of the four modular base plates 42-1, 42-2, 42-3, and 42-4 as attached to a plurality of wall studs 46.

FIG. 9 shows another example of four modular base plates 42-1, 42-2, 42-3, and 42-4 that can be arranged in an alternate configuration of a modular wall structure 84’.

Additional plates can be tiled together on a wall to create a larger modular wall structure for mounting larger accessories, or simply to cover a larger area. The plates can be installed "horizontally" or "vertically" or a mixture of both "horizontally" or "vertically", due to the plurality of mount features around the perimeter which do not all need to be used.

In one example, the plate material comprises a composite plastic that is strong enough to hold large loads but also slightly flexible to resist cracking when dropped, or breaking, when fasteners are tightened.

The subject disclosure also provides for a method comprising: providing at least a first base support application and a second base support application that is different than the first base support application, wherein one or more accessories 26 is selectively supportable on both the first base support application and the second base support application; configuring at least one base plate 20, 42 to include a plurality of apertures 30, 32, 34 that receive mounting feet 28 from the one or more accessories 26, wherein the plurality of apertures are comprised of a plurality of sub-groups 36 that each comprise a predetermined pattern that includes at least one mounting aperture 30, at least one locking aperture 32, and at least one power interface aperture 34; and forming the predetermined pattern to be the same for the first base support application and the second base support application.

The subject disclosure also provides for a method comprising: mounting at least one first base plate 20 in a vehicle cargo area 12; mounting at least one second base plate 42 to a base structure that is separate from the vehicle cargo area 12; forming a predetermined pattern of apertures in the at least one first base plate 20 and the at least one second base plate 42 to receive at least one accessory 26; selectively detaching the at least one accessory from one of the at least one first base plate and the at least one second base plate; and selectively attaching the same at least one accessory 26 to the other of the at least one first base plate and the at least one second base plate.

In one example, the method may further include forming the predetermined pattern of apertures to include at least one mounting aperture 30 for the at least one accessory, at least one locking aperture 32 for the at least one accessory, and at least one power interface aperture 34 for the at least one accessory.

In one example, the method may further include having the at least one second base plate 42 comprises a plurality of wall plates with mounting bosses 62 formed about a peripheral outer edge 48 of each wall plate, and including mounting the plurality of wall plates to one or more wall studs 46 by aligning mounting bosses from one wall plate to overlap with mounting bosses from an adjacent wall plate and inserting at least one fastener 52 through each aligned set of mounting bosses.

The subject disclosure provides for a base plate mounting configuration that can be used in a vehicle, as well as on walls in a stationary, non-vehicle application, and which allows accessories to be moved back and forth between the vehicle and a permanent work area in an easy and efficient manner. The subject disclosure provides for easy tiling without gaps between plates and may not require wall anchors when only wall stud fastening spacing is utilized. Additionally, a mounting pattern is provided that integrates inductive charging connections and locking connections for both vehicle and non-vehicle configurations.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. An attachment structure, comprising:
a base support comprising at least a first base support application and a second base support application that is different than the first base support application;
at least one base plate mountable to the base support, wherein the at least one base plate includes a plurality of apertures configurable to receive mounting feet from one or more accessories, wherein the plurality of apertures comprise a plurality of sub-groups that each comprise a predetermined pattern that includes at least one mounting aperture, at least one locking aperture, and at least one power interface aperture; and
wherein the predetermined pattern is the same for the first base support application and the second base support application.

2. The attachment structure of claim 1, wherein the first base support application comprises a vehicle cargo area.

3. The attachment structure of claim 2, wherein the second base support application comprises a supporting structure that is separate from the vehicle cargo area.

4. The attachment structure of claim 3, wherein the at least one base plate comprises at least one first base plate mounted in the vehicle cargo area and at least one second base plate mounted to the supporting structure, wherein the first base plate includes at least one sub-group of the plurality of sub-groups and the second base plate includes at least one sub-group of the plurality of sub-groups, such that the one or more accessories can be selectively detached from one of the at least one first base plate and the at least one second base plate and selectively attached to the other of the at least one first base plate and the at least one second base plate.

5. The attachment structure of claim 1, wherein the at least one base plate comprises a plurality of base plates, and wherein each base plate comprises an outer peripheral edge that includes a plurality of mount features, wherein a first mount feature from the plurality of mount features on a first base plate of the plurality of base plates overlaps a second mount feature from a second base plate of the plurality of base plates to secure the first base plate and the second base plate together.

6. The attachment structure of claim 5, including a plurality of fasteners that are used to secure overlapping first and second mount features from the plurality of mount features together.

7. The attachment structure of claim 6, wherein the first mount feature and the second mount feature are offset from each other in a direction along an insertion axis for an associated fastener from the plurality of fasteners.

8. The attachment structure of claim 5, wherein each base plate includes an outer accessory support surface and an inner surface that faces the base support, and wherein the plurality of mount features comprise bosses that extend outwardly of the outer peripheral edge and which are spaced apart from the outer accessory support surface in a direction toward the inner surface.

9. The attachment structure of claim 5, including a plurality of alignment features, wherein alignment features for one of the first base plate and the second base plate comprise female structures and alignment features for the other of the first base plate and the second base plate comprise male structures that fit into corresponding female structures.

10. The attachment structure of claim 9, wherein each base plate includes at least two alignment features associated with each mount feature, and wherein one of the at least two alignment features is on one side of each mount feature and the other of the at least two alignment features is on an opposite side of each mount feature.

11. The attachment structure of claim 1, wherein the at least one base plate comprises at least one first base plate associated with the first base support application and at least one second base plate associated with the second base support application, and wherein, for each sub-group, the at least one mounting aperture comprises a plurality of mounting apertures, the at least one locking aperture comprises a plurality of locking apertures, and the at least one power interface aperture comprises a single power interface aperture.

12. A method comprising:
providing at least a first base support application and a second base support application that is different than the first base support application, wherein one or more accessories is selectively supportable on both the first base support application and the second base support application;
configuring at least one base plate to include a plurality of apertures that receive mounting feet from the one or more accessories, wherein the plurality of apertures are comprised of a plurality of sub-groups that each comprise a predetermined pattern that includes at least one mounting aperture, at least one locking aperture, and at least one power interface aperture; and
forming the predetermined pattern to be the same for the first base support application and the second base support application.

13. The method of claim 12, wherein the first base support application comprises a vehicle cargo area and the second base support application comprises a fixed support structure that is separate from the vehicle cargo area.

14. The method of claim 13, wherein the at least one base plate comprises at least one first base plate mounted in the vehicle cargo area and at least one second base plate mounted to the fixed support structure, and including providing the plurality of sub-groups with the predetermined pattern on both the at least one first base plate and the at least one second base plate.

15. The method of claim 14, wherein the at least one second base plate comprises a plurality of modular wall plates with mounting bosses formed about a peripheral outer edge of each modular wall plate, and including mounting the plurality of modular wall plates to one or more wall studs by aligning mounting bosses from one modular wall plate to overlap with mounting bosses from an adjacent modular wall plate and inserting at least one fastener through each aligned set of mounting bosses.

16. The method of claim 15, wherein the plurality of modular wall plates comprise at least a first modular wall plate and a second modular wall plate, and wherein the mounting bosses include at least a first mounting boss associated with the first modular wall plate and a second mounting boss associated with the second modular wall plate, and including offsetting the first mounting boss from the second mounting boss in a direction along an insertion axis for the at least one fastener.

17. The method of claim 16, including providing a plurality of alignment features, wherein alignment features for one of the first modular wall plate and the second modular wall plate comprise recesses and alignment features for the other of the first modular wall plate and the second modular wall plate comprise protrusions that fit into corresponding recesses, and including spacing the plurality of alignment features apart from the mounting bosses.

18. A method comprising:
mounting at least one first base plate in a vehicle cargo area;
mounting at least one second base plate to a base structure that is separate from the vehicle cargo area;
forming a predetermined pattern of apertures in the at least one first base plate and the at least one second base plate to receive at least one accessory;
selectively detaching the at least one accessory from one of the at least one first base plate and the at least one second base plate; and
selectively attaching the same at least one accessory to the other of the at least one first base plate and the at least one second base plate.

19. The method of claim 18, including forming the predetermined pattern of apertures to include at least one mounting aperture for the at least one accessory, at least one locking aperture for the at least one accessory, and at least one power interface aperture for the at least one accessory.

20. The method of claim 19, wherein the at least one second base plate comprises a plurality of wall plates with mounting bosses formed about a peripheral outer edge of each wall plate, and including mounting the plurality of wall plates to one or more wall studs by aligning mounting bosses from one wall plate to overlap with mounting bosses from an adjacent wall plate and inserting at least one fastener through each aligned set of mounting bosses.
